(19) United States
(12) Patent Application Publication
(10) Pub. No.: US 2012/0048251 A1
(43) Pub. Date: Mar. 1, 2012

(54) LAUNCHER AND PROJECTILE TYPE PET TOY

(75) Inventors: Mark J. Oblack, Issaquah, WA (US); Kyle D. Burger, Seattle, WA (US); Mark D. Thinnes, Seattle, WA (US)

(73) Assignee: CANINE HARDWARE INC., Kent, WA (US)

(21) Appl. No.: 13/192,097

(22) Filed: Jul. 27, 2011

Related U.S. Application Data
(60) Provisional application No. 61/368,568, filed on Jul. 28, 2010.

(51) Int. Cl. F41B 3/04; A01K 29/00

(52) U.S. Cl. 124/5

(57) ABSTRACT

A pet toy suitable for indoor use includes an indoor launcher having a rigid handle, a flexible arm, and a C-shaped head attached to a distal end of the arm. The head is narrow at the central portion, and wider at the upper and lower lips. The ball is configured to be releasably retained in the head, and may be, for example, spherical or a center spherical segment. The ball comprises a foam core which may be hollow and vented, and a napped fabric covering. Optionally, the ball may include one or more straps. The ball characteristics provide high drag and rolling resistance to limit the path of the ball, and define a soft and compliant article suitable for indoor use. The optional straps provide greatly improved visibility. Limited travel and good visibility makes the balls particularly suitable for older or impaired pets.

### CROSS-REFERENCE TO RELATED APPLICATION

This application claims the benefit of Provisional Application No. 61/368568, filed Jul. 28, 2010, the entire disclosures of which are hereby incorporated by reference herein.

### BACKGROUND

Many dogs are natural retrievers that enjoy retrieving objects such as sticks or balls. Unfortunately, the stick or ball is thrown at great distances for long periods of time which makes a person's back and arm tired before the animal is ready to rest. To address this problem, the present inventor invented a ball-throwing apparatus disclosed in U.S. Pat. No. 6,076,829.

The inventor has found that many pet owners and their pets enjoy playing retrieving games indoors, or in more confined spaces. Often, particularly with older pets, it is preferable to play fetching games over shorter distances and with softer objects even when playing outdoors. In other situations, the space available for playing fetching games is limited or too crowded to accommodate longer distance activities.

Prior art devices for launching retrievable pet toys and the launchable toy itself are not suitable or optimized for indoor and/or short distance activities. In particular, prior art devices are typically designed to launch a ball or other projectile a long distance, with correspondingly high velocity and low drag.

An indoor launcher and suitable, projectile-type pet toys that address these problems are disclosed herein.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An indoor fetching pet toy suitable for indoor use includes a ball and an indoor launcher. The launcher includes a rigid handle, flexible arm, and a flexible, thin-walled head that is shaped to releasably retain the ball. The head includes a narrow central portion having a spherical inner surface that engages the retained ball, and relatively wide upper and lower lip portions that extend from the narrow central portion to define a throat therebetween. When the head is unflexed, the throat defined by the upper and lower lips is smaller than a diameter of the ball, and when the indoor launcher is swung to launch the ball the head flexes such that the throat widens to be larger than the diameter of the ball. In an embodiment the upper lip includes one or more teeth, such that the head imparts a spin to the ball when it is released.

In an embodiment, the indoor launcher is formed as a single, unitary, polymeric structure, and the upper lip has at least three inwardly-facing teeth.

In an embodiment, the ball is formed with a foam core, for example a polyolefin foam such as EVA, which is covered with a shag-type fabric cover, for example chenille.

In an embodiment, the foam core is formed as a hollow sphere, with at least one tubular vent that facilitates compressing and re-expanding the ball.

In another embodiment, the foam core is shaped as a center spherical segment with rounded edges, which may include a central aperture.

In an embodiment, the ball includes one or more straps.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a pet toy including an indoor launcher and a ball or projectile, which is shown in phantom;

FIG. 2A is a front view of the head portion of the indoor launcher shown in FIG. 1;

FIG. 2B is a side view of the head portion of the indoor launcher shown in FIG. 1;

FIG. 2C is a cross-sectional side view of the head portion of the indoor launcher shown in FIG. 1;

FIG. 3A is a perspective view of a spherical ball for use with the indoor launcher shown in FIG. 1;

FIG. 3B is a cross-sectional view of the spherical ball shown in FIG. 3A taken through section 3B-3B;

FIG. 4A is a front view of a spherical segment shaped ball with rounded edges suitable for use with the indoor launcher shown in FIG. 1;

FIG. 4B is a cross-sectional front view of the ball shown in FIG. 4A;

FIG. 5A is a perspective view of a spherical segment shaped ball similar to the ball shown in FIG. 4A, and having a transverse aperture therethrough;

FIG. 5B is a cross-sectional view of the spherical segment shaped ball shown in FIG. 5A taken through section 5B-5B; and

FIG. 6 illustrates use of the indoor launcher and ball shown in FIG. 1.

### DETAILED DESCRIPTION

A manually-operated indoor launcher is disclosed that is suitable for gripping, retrieving, holding, storing, and launching or throwing a compliant and compressible ball. In particular, the indoor launcher disclosed herein is an improvement and modification of the launcher the present inventor disclosed in U.S. Pat. No. 6,076,829, which is hereby incorporated by reference in its entirety. Certain unique projectiles or balls suitable for use with the present launcher are also disclosed. Although projectiles suitable for use with the present launcher are typically referred to herein as a “ball,” as discussed below, the projectiles may be spherical or alternatively shaped, for example as a spherical segment, with or without a central aperture. An exemplary alternatively-shaped ball is disclosed. The term “ball” is herein defined to mean any projectile shaped and configured to be retainable by and launchable by an indoor launcher in accordance with the present disclosure.

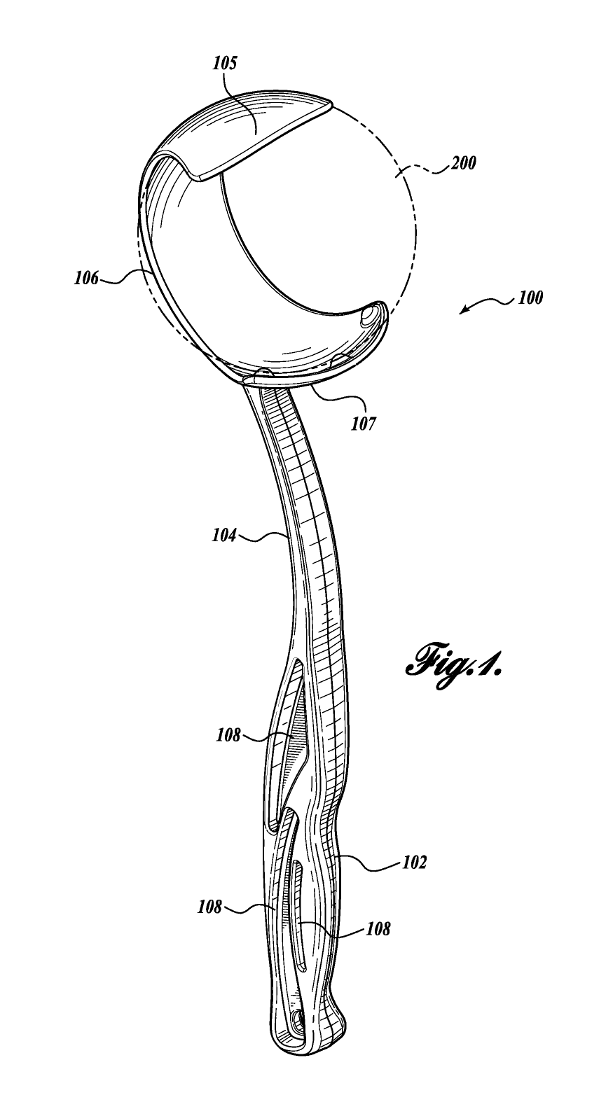

Refer now to the FIGURES, wherein like numbers indicate like parts. FIG. 1 shows an indoor launcher 100 in accordance with the present invention, with a ball 200 (shown in phantom) retained by the indoor launcher 100. The indoor launcher 100 includes a handle 102, an arm 104 extending distally from the handle 102, and a head 106 fixed to a distal end of the arm 104. In a currently preferred embodiment, the indoor launcher 100 is formed as a single, unitary structure. For example, the indoor launcher 100 may be formed from rigid modeling resins that reasonably simulate injection-molded plastics, an injection-molded thermoplastic, a co-molded assembly of different injection-molded plastics, thermosets or insert moldings that incorporated solid, pre-cured or pre-molded piece parts, or the like. Selection of suitable materials is within the skill in the art.

For durability and cost, currently preferred materials of construction include olefinic homopolymers and copolymers. Using reinforced thermosets or moderate/high-temperature thermoplastics, or incorporating localized use of these materials would result in lighter weight devices with slightly different, though completely workable, handling characteristics. Natural materials, either whole or as reinforcing fibers, panels, stringers, fillers, moldings, or zones, could also be used and achieve similar functionality and utility.

The handle 102 is contoured to be comfortably gripped by the user and may include cutouts and/or recesses 108 that may reduce weight and increase gripping comfort. The cutouts and/or recesses 108 may also provide decorative attributes. Although not shown, it is contemplated that the handle 102 may include a separately-applied grip or wrapping, for example, a leather or faux leather tape. In the present embodiment the handle 102 is approximately 8 inches long, and is constructed to be substantially rigid, such that the handle 102 does not flex appreciably during normal use.

The arm 104 extends from the handle 102, and is elastically flexible. In the current embodiment there is no clear demarcation or joint between the handle 102 and the arm 104. Rather, the handle 102 narrows in thickness and smoothly transitions to the arm 104. Optionally the arm 104 may also taper in width from the handle 102 to the head 106. The arm 104 is shaped to produce a desired flexibility such that when the indoor launcher 100 is swung to launch the ball 200, the arm 104 elastically flexes. The energy stored in the flexure of the arm 104 is typically released as the user continues and/or slows the swing, facilitating launch of the ball 200. In a current embodiment, the arm 104 is between 5 and 10 inches in length. In a preferred embodiment, and unlike prior art launchers, the flexible arm 104 is shorter than the rigid handle 102. This provides particular advantages for indoor use, wherein the velocity and travel distance of the ball 200 is preferably limited.

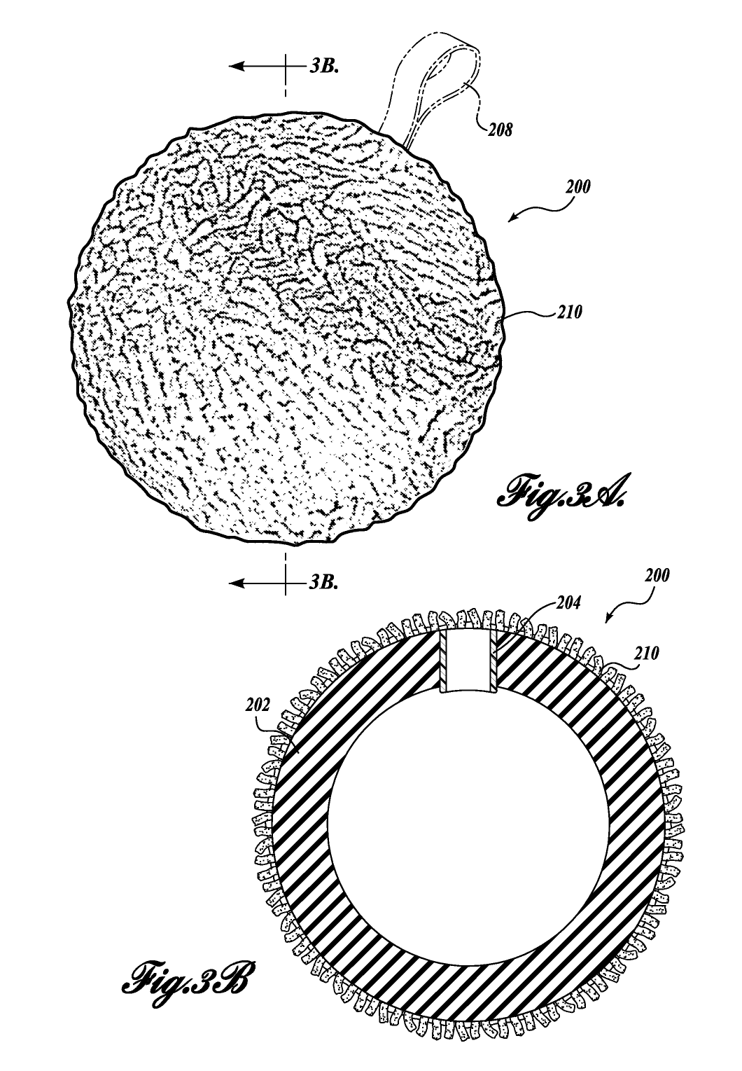

The head 106 is fixed to the distal end of the flexible arm 104. In the current embodiment, the head 106 is integrally formed with the handle 102 and the arm 104. The head 106 is generally C-shaped (see FIG. 3C), and is designed to releasably retain the ball 200, as discussed below. The C-shaped head 106 is formed from a thin, elastically flexible material, which may be the same material as the handle 102 and the arm 104. Although in the current embodiment the desired flexibility of the head 106 is achieved by the shape of the head 106, it will be readily appreciated that the desired head flexibility may alternatively or cooperatively be achieved by other means, for example, by co-molding the head 106 using a more flexible polymer than the handle 102 and arm 104, forming a living hinge in the head, heat-treating the head to attenuate its flexibility, etc.

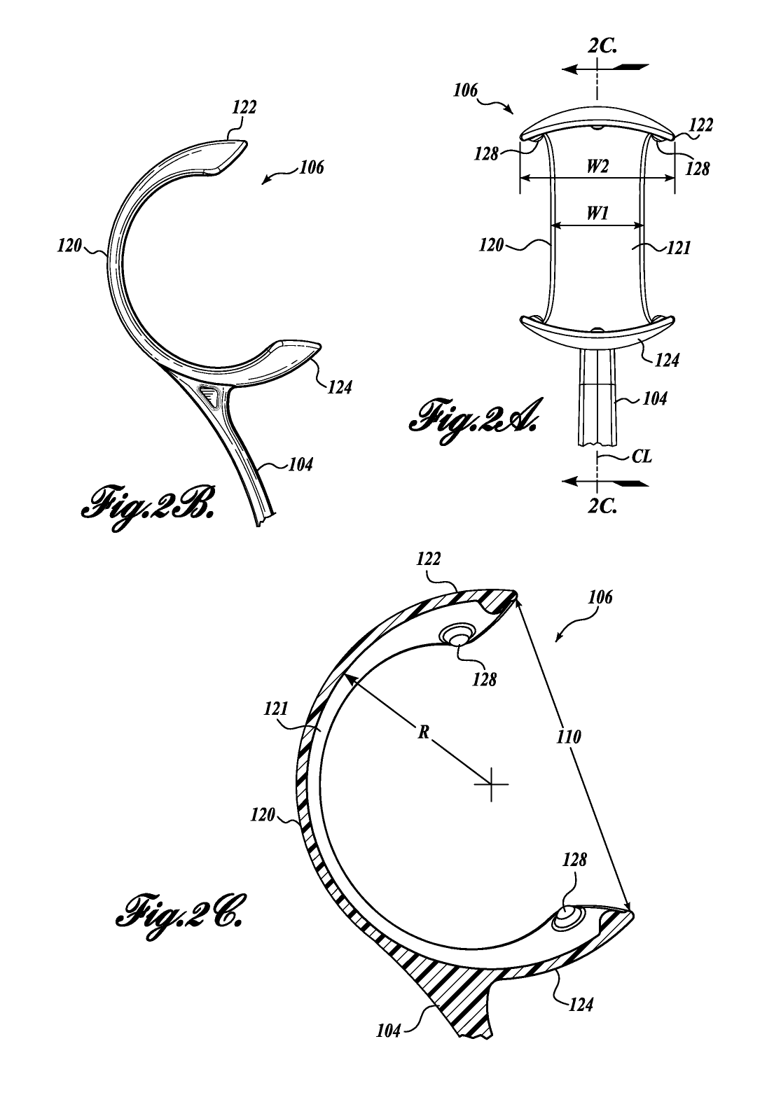

When no external forces are applied, the head 106 defines a throat or opening 110 (see FIG. 2C) that is smaller than the characteristic diameter of the ball, e.g., the diameter of the ball 200, such that the ball 200 may be securely retained by the head 106. In particular, the head 106 is designed to grip or retain the ball 200 with a “snap-fit.” “Snap-fit” is defined to mean a retaining fit wherein the retaining structure elastically flexes to receive an article such as a ball, and further, wherein when the flexing force is released, the structure returns to or near a relaxed shape to releasably retain the article.

As shown in FIG. 1, the arm 104 engages the head 106 on a proximal section 107 of the C-shaped head 106. The head 106 is configured as discussed below such that when a user grasps the indoor launcher 100 by the handle 102 (with the ball 200 retained by the head 106) and swings the indoor launcher 100 in an arc, momentum and acceleration forces will urge the distal section 105 of the head 106 away from the proximal section 107, thereby enlarging the opening 110 to release the ball 200. The present indoor launcher 100 is particularly suited for gripping and throwing soft-surfaced lightweight articles suitable for use indoors.

Refer now to FIGS. 2A-2C. FIG. 2A shows a detail front view of the launcher showing the head 106, FIG. 2B shows a detail side view of the head 106, and FIG. 2C shows a corresponding cross-sectional side view of the head 106, through centerline CL.

The head 106 comprises a narrow central portion 120, a wider upper lip portion 122, and a wider lower lip portion 124. The narrow central portion 120 defines a curved inner surface 121 that is shaped at least in part as a centered spherical zone, i.e., the surface of a centered spherical segment, having radius R (FIG. 2B). In a current embodiment the diameter of the spherical inner surface 121 is between 3.5 inches and 4.5 inches, and most preferably between 4.3 inches and 4.5 inches.

Unlike prior art launching devices, the transverse dimension of the narrow central portion 120 has a substantially constant width W1 defining the minimum width of the head 106. The transverse width of the head 106 increases in either direction to define the wider upper lip portion 122 on one end, and to define the wider lower lip portion 124 at the opposite end. It will be appreciated that the contoured width of the head 106, with the central portion 120 defining the minimal width W1, allows the head 106 to readily flex to widen the throat 110. This flexibility facilitates launching the ball 200 at lower speeds and eases inserting the ball 200 into the head 106.

The upper lip portion 122 extends or continues forwardly from one end of the central portion 120. The upper lip portion 122 is curvilinear in shape, and in a current embodiment, extends spherically from the spherical inner surface 121 of the central portion 120. The transverse dimension of the upper lip portion 122 increases to a maximum width W2 near the distal end. The lower lip portion 124 similarly extends smoothly from the other end of the central portion 120. The upper and lower lip portions 122, 124 curve inwardly from the central portion 120 to define the throat or opening 110. Optionally, the upper and lower lip portions 122, 124 include one or more teeth 128 (three shown) that facilitate retention of the ball 200 and improve launching performance. The teeth may be elongate in the transverse direction. The teeth 128 are particularly suitable for use with a compliant ball, and most especially for a ball having a textured outer surface, such as balls 200, 300 described below.

The head 106 will therefore overlie only a relatively narrow strip of a spherical ball 200 retained in the head 106. The wider upper and lower lip portions 122, 124 retain the ball 200 in the head 106 generally engaging the ball 200 at a bottom and top end (relative to the head 106). It should be appreciated that this configuration produces very different ball grasping and releasing characteristics from prior art launchers that engage the ball from the sides and/or that taper in width at the throat to the launcher head.

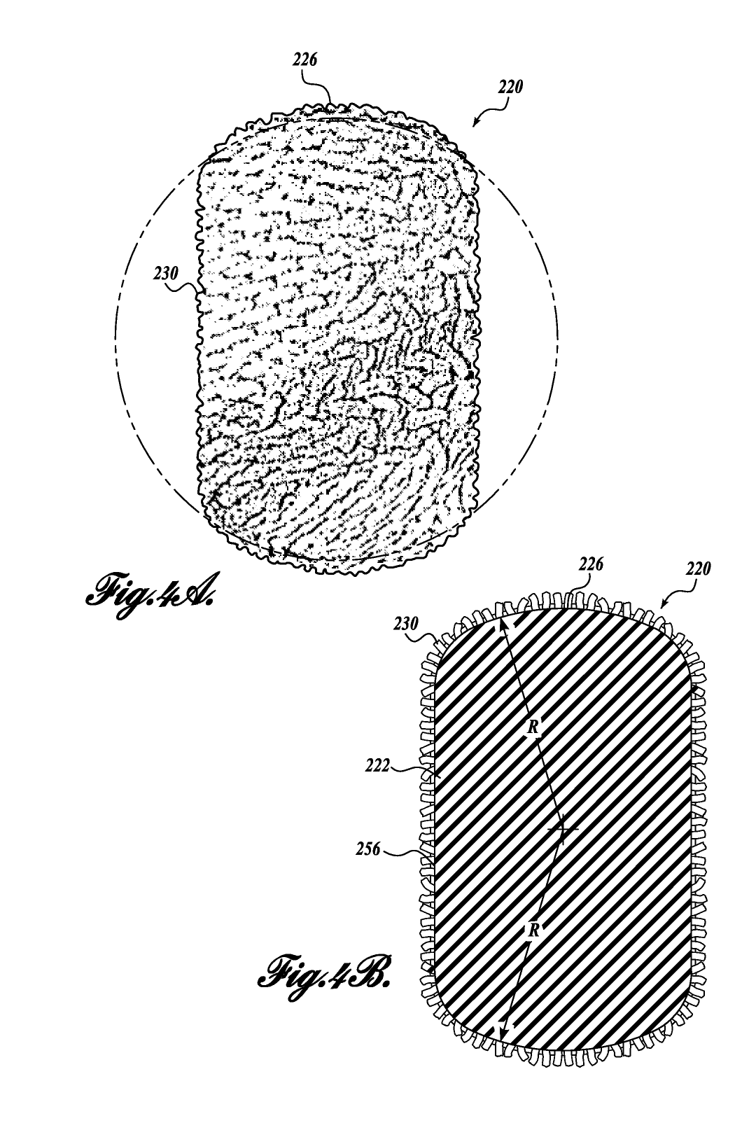

The unique shape of the head 106 also allows the indoor launcher 100 to be used with balls having a generally spherical outer surface and flat sides, comprising a spherical zone or frustum, for example, as discussed below with reference to FIGS. 4A and 4B. In addition, the head 106 is suitable for use with balls having appendages such as straps or the like, without significant interference.

The construction of the indoor launcher 100 must balance stiffness with flexibility, to be used effectively to launch a lightweight ball 200. The design considerations for an indoor launcher 100 are different from outdoor launching toys due to practical constraints relating to indoor use, including the use of a softer and lighter ball, the desire for lower ball speeds, typically lesser throwing forces, etc. The handle 102 must be stiff enough to manipulate the launcher 100 and the ball 200 during retrieval. The head 106 is designed to securely retain the ball 200 once it is acquired, to release the ball 200 with the proper swing of the launcher 100, and to accurately control the release direction.

A first ball 200 particularly suitable for launching with the indoor launcher 100 disclosed above is shown in FIGS. 3A and 3B. In this embodiment, the ball 200 is generally spherical and sized to be releasably retained by the head 106 of the indoor launcher 100.

Optionally, the ball 200 may have a strap 208 secured to the ball 200. The strap 208 may serve a number of purposes, most importantly providing alternatively playing modes for use with the user's dog. For example, the strap 208 may be used in tug-of-war types of games. In a current embodiment the strap 208 has a length between 0.1 and 2 times the diameter or width of the ball 200. In certain embodiments, the ball 200 may include multiple straps 208. The strap 208 may be made of elastic or low stretch material, including natural or synthetic rubber, natural fibers, man made fibers (e.g., nylon, polypropylene, polyester, Kevlar), or soft woven or braided metals. In exemplary embodiments, the strap 208 comprises one or more of: a rope (or plurality of ropes), a generally flat webbing, tape or flat polymer extrusion, or tubular webbing, extruded polymer tubing, or hollow braid.

The strap(s) 208 may also greatly improve the visibility of the ball 200 during use, which may be particularly beneficial for playing with (and exercising) older and/or visually impaired pets. The strap(s) 208 will also affect the rolling and bouncing characteristics of the ball 200 in an essentially unpredictable manner. It will be appreciated that an element of unpredictability in the dynamic behavior of the ball 200 will add an element of surprise to further improve the fun and exercise for the pet.

The strap 208 may be fixedly attached to the ball 200 or may be detachable for easy replaceability. Fixed attachments include sewing, variable width or variable diameter weaving, rivets, thermal bonding, adhesive bonding, knotting, and attachments that use constrained geometries like self-energizing wedge/groove or ball/socket interference fits. Detachable and/or replaceable configurations include attachment by hook and loop devices, buttons, mechanical snaps, spring gate snaps, magnets, knots, loops, and interference fits.

As seen most clearly in the cross-sectional view of FIG. 3B, the ball 200 includes a hollow, resilient core 202 that is enclosed by the outer covering 210. The core 202 is made from a foam polymeric material and may be formed by any conventional means, including, for example, blow molding, rotational molding (also known as rotomolding, rotocasting or spin casting), or the like.

The core 202 is resilient. In certain embodiments, the resiliency may be achieved with: (1) an airtight, high elongation exterior surface over a sealed airspace, bladder or enclosure, (2) using a permeable or semi-permeable deformable exterior surface over a high elongation, highly resilient core, or (3) by using a very lightweight closed cell foam core.

In the embodiment shown in FIG. 3B, the core 202 comprises a hollow sphere or spheroidal shell formed from a polymeric foam, for example a polyolefin foam such as polyethylene (PE), polypropylene (PP) and/or ethyl vinyl acetate (EVA). In other embodiments the core 202 may comprise a resilient open cell foam made from polyester or polyether polyurethane or open cell polyolefin. In an alternative embodiment, the core 202 is formed of reticulated polyether polyurethane foam. Reticulated foam is a very porous, low density solid foam. Reticulated foams have many advantages for the present application. Reticulated foams are extremely open foams, i.e., there are few, if any, intact bubbles or cell windows. Thermal or chemical reticulation results in void volumes of up to 98%, allowing for the very low density assemblies that are appropriate for indoor use, play, and training.

Reticulated polyether polyurethane foam is resistant to most chemicals, including water, soaps, detergents, most cleaning solvents, most cleaning agents, solvents, alkalis, and acids and dilute bleaches, making the device easy to clean and maintain. Select formulations of polyurethane foams are considered “non nutrients,” i.e., they are not ingested by microbial organisms and are available with permanent fungicidal/bactericidal additives for enhanced antimicrobial activity. Built in fungicidal additives can be incorporated into the polymer to inhibit fungus and mildew, both important for retarding stain and odor. These factors make the device durable and long lasting. Use of reticulated foam in the core of the device allows it to dry very rapidly after exposure to rain, salt spray, morning dew, washing, or other forms of moisture and humidity. Large, open pores allow maximum water drainage and air circulation, permitting use quickly after being wet or even saturated.

The foam core 202 has sufficient thickness that the core 202 will return to its original shape if it is elastically deformed. However, it has been found preferable that the spheroidal core 202 not be sealed. The core 202 in this embodiment includes one or more (one shown) vents or tubes 204 that extend through the thickness of the core 202 wall. The tubes 204 fluidly connect the interior of the core 202 with the exterior ambient space, such that the core 202 will readily expel air from the interior if squeezed and will easily return to its original shape when the compressing force is removed.

Functional closed cell core foams suitable for construction of the core 202 include cross-linked polyolefin and copolymers of cross-linked polyolefin and ethylene vinyl acetate (EVA). Preferably the density of closed cell core foams is less than 3 pounds per cubic foot (pcf), more preferably less than 2.5 pcf, and most preferably 2.2 pcf or less.

In another embodiment the core comprises a fiber filling, composed of either synthetic or natural fibers, disposed in an exterior covering. For example, the fibers may be polyester fibers.

The textured fabric outer covering 210 encloses the core 202, and may be formed from, for example, an acrylic or acrylic blend, nylon, polyester, wool, cotton, bamboo, viscose, or other natural or man made fibers or blends of fibers in woven, knit, braided, felted, and spun bonded constructions or combinations of these constructions.

In a preferred embodiment, the outer covering 210 includes a predominance of deep pile textured fabric with long cut surface yarns, often referred to as “shag” or “chenille.” The shag length may be long, short, and/or mini. For example, the outer covering may be made from flokati, a wool shag material often used in rugs. The outer covering 210 may simply enclose the core 202 or may be bonded or otherwise fixed to the core. Alternatively, it may be locally stitched to the core.

Chenille is the currently preferred material for the covering 210 because the material will mitigate impact forces that occur during indoor use. The low mass and low density combined with the soft exterior result in a gently landing, soft device that is pleasing and comforting to the touch. The high surface area and porosity of the chenille pile allows additional utility as a scent retaining device. Scents can be used either for aesthetic or for training purposes. The nap of the material can also be used as a delivery device for powder borne medicines and treatment media.

The textured fabric outer covering 210 also advantageously increases the aerodynamic drag of the ball 200 during flight and the rolling resistance of the ball 200. The increased drag and resistance will thereby reduce the distance the ball 200 travels. The strap(s) will have similar advantageous effects. Therefore, the flight characteristics may be optimized by the designer through selection of the covering 210 material and the strap 208 configuration. The improved visibility provided by the straps 208 (as discussed above) and the increased flight drag and resistance, as well as the random bounce characteristics, provide great advantages when playing with pets having limited visual and physical abilities.

The selection of low density, low mass core materials and soft exterior materials make the device particularly suited to indoor use. When thrown or launched, flight distance is relatively short and impact forces are low. Use of “fuzzy” pile over significant portions of the ball 200 further lessens localized impact forces. Integrated use of strap(s) 208 offers additional flight orientation, and this can be used to preferentially cause the device to land in the softest orientation(s). In a current embodiment, the total weight of the device is less than 100 grams, more preferably less than 80 grams, and most preferably less than 60 grams.

The main anticipated use of the ball 208 is as a dog's indoor fetch toy, which may be thrown or launched with the launcher disclosed above. The inclusion of one or more straps 208 also allows the device to be used as a tug toy.

A less obvious use of the device is as a “speed bag.” This use occurs when a dog holds the handle of the device and rotates its head quickly. When this is done, the device alternately raps the dog's muzzle on the left, then right, then left, etc., sides, further stimulating the dog to continue to shake the device.

The size and shape of the ball 200 allows launching by hand, using either the body or the strap(s) 208, or with the assistance of the indoor launcher 100, as described above. This allows the ball 200 to be used in a wide variety of environments from small enclosed spaces to larger open areas.

The spherical portion of the ball 200 and the location of the strap(s) 208 are such to allow the indoor launcher 100 to attach securely to the ball 200. The snap fit of the ball 200 to the indoor launcher head 106 provides enough retention to allow the ball 200 to be picked up from the ground directly with the launcher 100 and subsequently launched without the user directly touching or grasping the ball 200. The shape of the ball 200 and the size of the handle 102 and arm 104 of the launcher 100 have the added utility of making it easier for a human to pick up the ball 200 from the ground.

FIG. 4A is a front view of a ball 220 suitable for use with the indoor ball launcher 100 described above. FIG. 4B is a cross-sectional front view of the ball 220 through a center plane. The ball 220 is generally shaped as a centered spherical segment from a center portion of a sphere, with the base edges rounded. A spherical segment is conventionally defined as the solid defined by cutting a sphere with a pair of parallel planes. The spherical outer surface of a spherical segment is called a spherical zone or frustum. As used herein, a center spherical segment refers to a spherical segment comprising a center segment of a sphere, i.e., a spherical segment centered on a circumference of the sphere.

The outer perimeter portion 226 of the ball 220 is shaped as the spherical zone of a center spherical segment. The spherical zone portion 226 of the ball 220 has a radius R that is approximately the same as the radius R of the head 106, shown in FIG. 2C, such that the ball 220 will engage the spherically curved inner surface 121 of the head 106.

The ball 220 includes a resilient core 222, which may be formed from a polymeric foam, for example a polyolefin foam or the like. In this embodiment, the resilient core 222 does not include a center void, and therefore no venting tube or the like is included. A textured fabric outer covering 230 surrounds the core 222, and may comprise, for example, a shag material such as chenille, as discussed above.

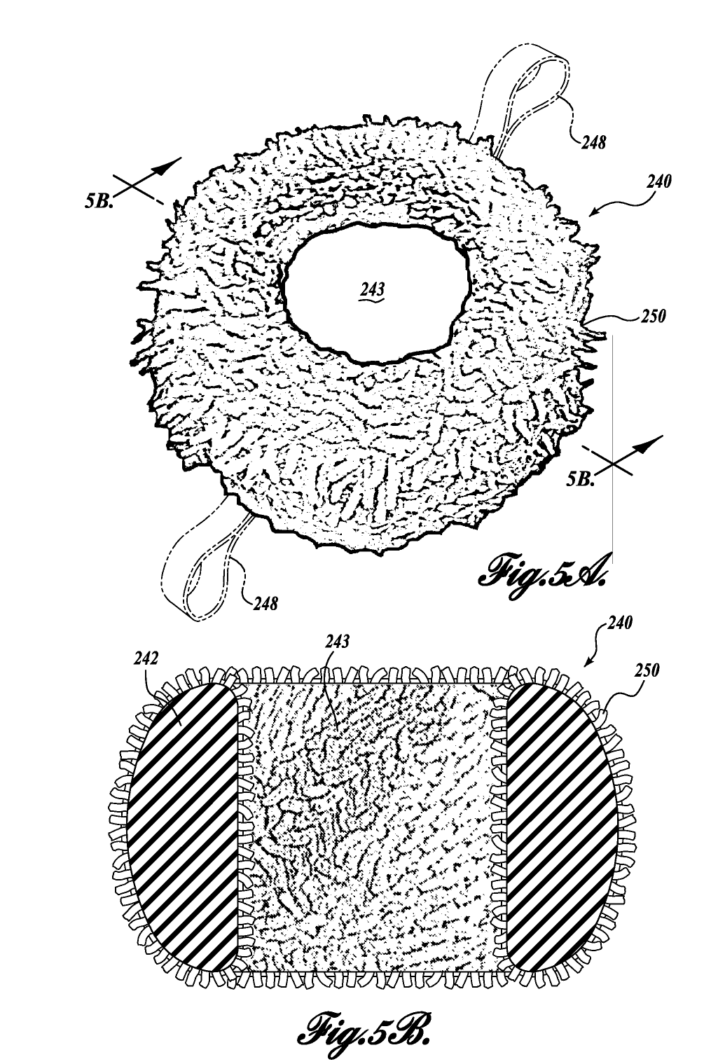

Refer now to FIGS. 5A and 5B, which show a perspective view and cross-sectional view, respectively, of another embodiment of a ball 240 in accordance with the present invention. The ball 240 is similar to the ball 220 described above, and is also shaped generally as a center spherical segment. However, the ball 240 further includes a central aperture 243. The ball 240 includes a resilient and compressible polymeric core 242. The core 242 in this embodiment is formed without an internal void. The shape provides the desired resilient flexibility and low weight.

The outer spherical zone section of the ball 240 has a characteristic diameter such that the ball 240 may be releasably retained by the head 106 of the indoor launcher 100 shown in FIG. 1. The inner core 242 is covered or enclosed by a fabric outer covering 250, which is preferably formed from a shag-type fabric, such as chenille. The ball 240 may further include one or more straps 248 (two shown in phantom), which may be substantially similar to the straps 208 described above.

It will be appreciated that the balls 220 and 240 have different flight and rolling characteristics than the generally spherical ball 200 described above. However, the balls 220, 240 may be launched with the indoor launcher 100 in the same matter as the spherical ball 200.

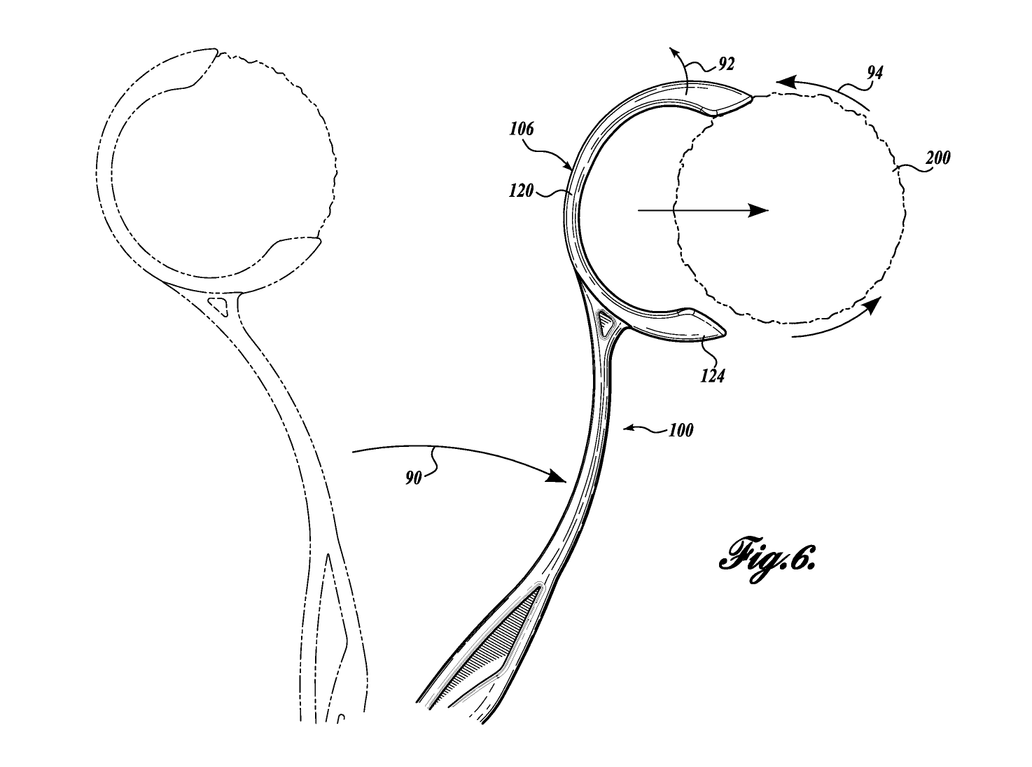

FIG. 6 illustrates the indoor launcher 100 throwing characteristics. As the user swings the launcher 100 in a forward arc, as indicated by arrow 90, centrifugal and momentum forces will press the ball 200 (or balls 220 or 240) outwardly against the upper lip portion 122 of the head 106. The narrow central portion 120 of the head 106 flexes in response to the forces such that the upper lip portion 122 pivots or flexes away from the lower lip portion 124, as indicated by arrow 92. The ball 200 may therefore be released from the head 106. The ball 200 is urged against the upper lip portion 122 as it is released, and therefore the indoor launcher 100 will impart a spin to the ball 200, as indicated by arrow 94. The spin improves the aerodynamic flight of the ball 200. If the ball 200 is launched with an overhand throwing motion as indicated in FIG. 5, the ball 200 would typically strike the ground with a reverse spin, thereby limiting the rolling distance. Alternatively, if the user elects to throw the ball 200 using an underhand motion, such that the ball 200 releases from the indoor launcher 100 near the bottom of its arc, the spin imparted to the ball 200 would tend to increase the rolling distance.

While illustrative embodiments have been illustrated and described, it will be appreciated that various changes can be made therein without departing from the spirit and scope of the invention.

The embodiments of the invention in which an exclusive property or privilege is claimed are defined as follows:

1. A pet toy suitable for indoor use comprising:
a ball having a diameter;
an indoor launcher having a substantially rigid handle, a flexible arm with a first end fixed to the handle and a second end, and a flexible thin-walled head fixed to the second end of the arm and configured to releasably retain the ball;
wherein the head comprises (i) a central portion having a relatively narrow transverse width, the central portion having a spherical inner surface, (ii) an upper lip portion that extends from a proximal end of the central portion, the upper lip being wider than the central portion, the upper lip further comprising an inwardly facing tooth; and (iii) a lower lip portion that extends from a distal end of the central portion, the lower lip being wider than the central portion; and
wherein in an unflexed configuration, the upper lip portion and the lower lip portion define a throat width therebetween that is smaller than the diameter of the ball, and further, wherein the central portion is sufficiently elastically flexible to enable a user to swing the indoor launcher and ball in an arc such that the central portion of the head flexes elastically to move the upper lip portion away from the lower lip portion to increase the throat width to a size greater than the diameter of the ball.

2. The pet toy of claim 1, wherein the indoor launcher is formed as a single, unitary structure.

3. The pet toy of claim 2, wherein the flexible arm is shorter than the substantially rigid handle.

4. The pet toy of claim 1, wherein the upper lip portion comprises at least three inwardly facing teeth.

5. The pet toy of claim 1, wherein the head increases in width monotonically from the narrow central portion to the upper and lower lip portions.

6. The pet toy of claim 1, wherein the ball comprises a foam core and a napped fabric cover.

7. The pet toy of claim 6, wherein the napped fabric cover comprises chenille.

8. The pet toy of claim 6, wherein the foam core comprises a polyolefin foam.

9. The pet toy of claim 8, wherein the polyolefin foam comprises ethyl vinyl acetate.

10. The pet toy of claim 6, wherein the foam core defines a hollow sphere.

11. The pet toy of claim 10, wherein the foam core further comprises at least one tubular vent extending through a wall of the hollow sphere.

12. The pet toy of claim 6, wherein the foam core is shaped as a center spherical segment with rounded edges.

13. The pet toy of claim 12, wherein the foam core further comprises a center aperture.

14. The pet toy of claim 12, wherein the napped fabric defines a covering enclosing the foam core.

15. The pet toy of claim 6, wherein the ball comprises at least one strap that is attached to the napped fabric cover.

16. The pet toy of claim 1, wherein the ball diameter is between 3.5 inches and 4.5 inches.

17. A pet toy comprising:
a ball defining a first characteristic diameter;
a one-piece indoor launcher having a relatively long substantially rigid handle, a relatively short flexible arm with a first end fixed to the handle and a second end, and a flexible head fixed to the second end of the flexible arm and configured to releasably retain a ball;
wherein the head consists of a C-shaped retainer having a relatively wide upper segment having a plurality of teeth, a relatively wide lower segment, and a relatively narrow central segment that joins the upper and lower segments, wherein the inner surface of the C-shaped retainer defines a spherical surface having a diameter approximately equal to the first characteristic diameter; and
wherein in an unflexed configuration the upper segment and the lower segment define a throat width therebetween that is smaller that the first characteristic diameter, and further, wherein the central portion is sufficiently elastically flexible to enable a user to swing the indoor launcher and ball in an arc such that the throat width increases to a width larger than the first characteristic diameter.

18. The pet toy of claim 17, wherein the ball comprises a foam core that is enclosed by a napped fabric covering.

19. The pet toy of claim 18, wherein the napped fabric covering comprises chenille.

20. The pet toy of claim 19, wherein the ball is substantially spherical.

21. The pet toy of claim 18, wherein the foam core is shaped as a central spherical segment with rounded edges and a center aperture.

22. The pet toy of claim 18, wherein the ball further comprises at least one external strap.
